(19) United States
(12) Patent Application Publication
(10) Pub. No.: US 2017/0307733 A1
(43) Pub. Date: Oct. 26, 2017

(54) VEHICLE RADAR METHODS AND SYSTEMS

(71) Applicants: Inna STAINVAS OLSHANSKY, Modiin (IL); Igal BILIK, Rehovot (IL); GM GLOBAL TECHNOLOGY OPERATIONS LLC, Detroit, MI (US)

(72) Inventors: INNA STAINVAS OLSHANSKY, MODIIN (IL); IGAL BILIK, REHOVOT (IL)

(73) Assignee: GM GLOBAL TECHNOLOGY OPERATIONS LLC, Detroit, MI (US)

(21) Appl. No.: 15/524,593

(22) PCT Filed: Jul. 3, 2014
(86) PCT No.: PCT/US14/45475

§ 371 Date: May 4, 2017

(51) Int. Cl. G01S 7/41; G01S 13/87; G01S 13/93; G01S 7/00

(52) U.S. Cl. CPC G01S 7/41; G01S 13/931; G01S 7/003; G01S 13/87; G01S 2013/936

(57) ABSTRACT

Methods and systems are provided for classifying an object proximate a first vehicle having a first radar system. First information is received from a first radar signal of the first radar system pertaining to the object. Second information is received from a second radar signal of a second vehicle pertaining to the object. The object is classified using the first information and the second information.

### CROSS REFERENCE TO RELATED APPLICATION

This application is a U.S. National-Stage entry under 35 U.S.C. §371 based on International Application No. PCT/US14/45475, filed Jul. 3, 2014 which was published under PCT Article 21(2) and is incorporated in its entirety herein.

### TECHNICAL FIELD

This application pertains to methods and systems for radar systems for vehicles.

### BACKGROUND

Certain vehicles today utilize radar systems. For example, certain vehicles utilize radar systems to detect other vehicles, pedestrians, or other objects on a road in which the vehicle is travelling. Radar systems may be used in this manner, for example, in implementing automatic braking systems, adaptive cruise control, and avoidance features, among other vehicle features. While radar systems are generally useful for such vehicle features, in certain situations existing radar systems may have certain limitations.

Accordingly, it is desirable to provide techniques for radar system performance in vehicles, for example pertaining to the classification of objects proximate a vehicle. It is also desirable to provide methods, systems, and vehicles utilizing such techniques. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a method is provided for classifying an object proximate a first vehicle having a first radar system. The method comprises receiving first information from a first radar signal of the first radar system pertaining to the object, receiving second information from a second radar signal of a second vehicle pertaining to the object, and classifying the object using the first information and the second information.

In accordance with an exemplary embodiment, a radar control system is provided. The radar control system comprises a first receiver, a second receiver, and a processor. The first receiver is configured to receive first information from a first radar signal of a first radar system of a first vehicle pertaining to an object proximate the first vehicle. The second receiver is configured to receive second information from a second radar signal of a second radar system of a second vehicle pertaining to the object. The processor is coupled to the first receiver and the second receiver, and is configured to classify the object using the first information and the second information.

### DESCRIPTION OF THE DRAWINGS

The present disclosure will hereinafter be described in conjunction with the following drawing figures, wherein like numerals denote like elements, and wherein:

FIG. 1 is a diagram of a plurality of vehicles having respective radar control systems that work together for detection of objects, in accordance with an exemplary embodiment;

FIG. 2 is a schematic illustration of the plurality of vehicles of FIG. 1, depicted on a roadway proximate an intersection, in accordance with an exemplary embodiment;

FIG. 3 is a functional block diagram of one of the vehicles of FIGS. 1 and 2, in accordance with an exemplary embodiment;

FIG. 4 is a functional block diagram of the control system of the vehicle of FIG. 3, including a radar system, in accordance with an exemplary embodiment; and

FIG. 5 is a functional block diagram of a transmission channel and a receiving channel of the radar system of FIGS. 3 and 4, in accordance with an exemplary embodiment;

FIG. 6 is a flowchart of a method for implementing the radar system of a vehicle, which can be used in connection with the vehicles of FIGS. 1-3, the control system of FIGS. 3 and 4, and the radar system of FIG. 5, in accordance with an exemplary embodiment; and

FIG. 7 provides a set of graphical illustrations pertaining to the classification of an object in accordance with the process of FIG. 6, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

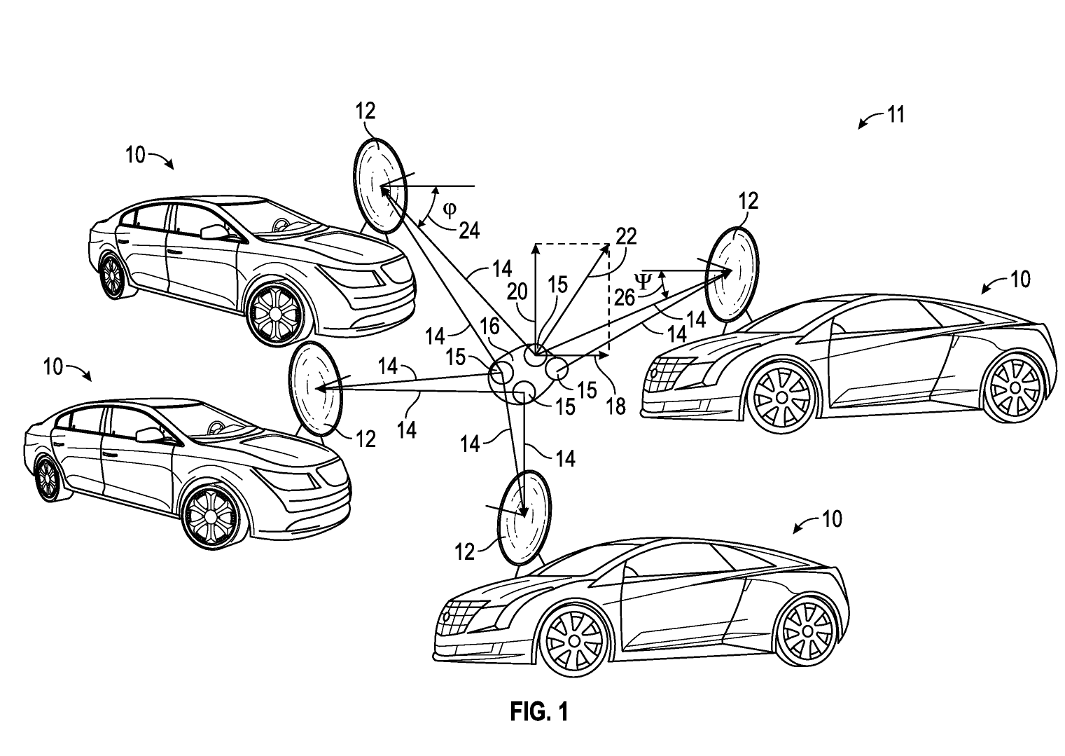

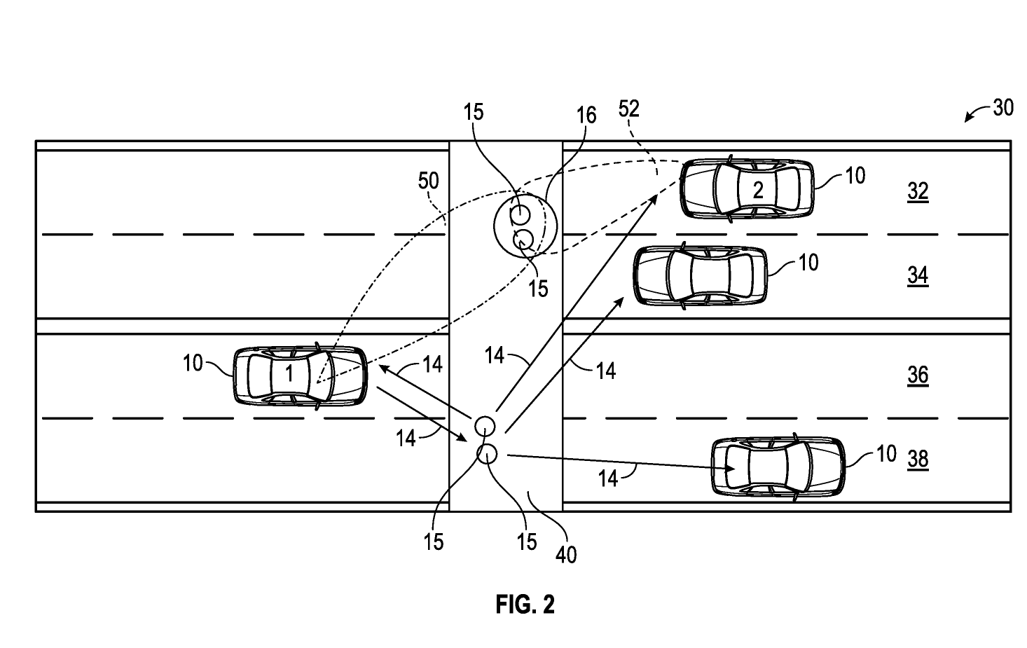

FIG. 1 is a diagram of a plurality of vehicles 10. The vehicles 10 each have respective radar control systems 12 that work together for detection of objects, in accordance with an exemplary embodiment. The vehicles 10 are also depicted in FIG. 2 along a roadway 30 with an intersection having a crosswalk 40, in accordance with an exemplary embodiment.

As depicted in FIGS. 1 and 2, the vehicles 10 each have a radar control system 12 onboard the respective vehicle 10. The radar control system 12 of each vehicle 10 generally comprises a multiple input, multiple output (MIMO) radar system having multiple transmitters and receivers. The radar control system 12 of each vehicle 10 transmits and receives radar signals 14 that come into contact with objects 15 along the roadway 30. In one embodiment, the radar signals 14 from the radar control systems 12 of multiple vehicles 10 each contact an object 15 and are redirected to the different radar control systems 12 of the various vehicles 10. Accordingly, the radar control system 12 of each particular vehicle 10 receives the return radar signals (or echoes) from the radar signals 14 that originated from the radar control system 12 of the particular vehicle 10 itself (also referred to as the host vehicle) before contacting the object 15, as well as radar signals 14 that originated from the radar control systems 12 of other nearby vehicles 10 before contacting the object 15. As used herein, in various embodiments the term “object” may refer to any moving or non-moving matter on or along the roadway, including, but not limited to, a pedestrian, a bicyclist, an animal, a motorcycle, another automobile, another type of vehicle, a boulder, a tree, a power line, roadway debris, and/or one or more various other types of objects.

In one embodiment, each radar control system 12 classifies the object based on each of the received radar signals from the radar control system 12 itself as well as the radar control systems 12 of the other nearby vehicles 10. In certain embodiments, the terms “classify”, “classifies”, “classification”(s), and/or variations thereof refer to classifications and/or determinations as to the type of object (e.g., vehicle versus pedestrian versus road debris, and so on), the size and/or dimensions of such object, the location and/or placement of the object, and the movement (e.g., speed and direction) of the object 15. In addition, in one embodiment, each of the radar control systems 12 of the various vehicles 10 broadcasts its classifications to the other nearby vehicles 10, receives broadcasts of respective classifications from the corresponding radar control systems 12 of the other nearby vehicles 10 pertaining to the object 15, and updates its classification accordingly based on the classifications from the other nearby vehicles 10.

The radar control system 12 of each vehicle 10 transmits and receives radar signals 14 that come into contact with objects 15 along the roadway 30 (FIG. 2). In one embodiment, the radar signals 14 from the radar control systems 12 of multiple vehicles 10 each contact an object 15 and are redirected to the different radar control systems 12 of the various vehicles 10. Accordingly, the radar control system 12 of each particular vehicle 10 receives the return radar signals (or echoes) from the radar signals 14 that originated from its own radar control system 12 as well as radar signals 14 that originated from the radar control systems 12 of other nearby vehicles 10.

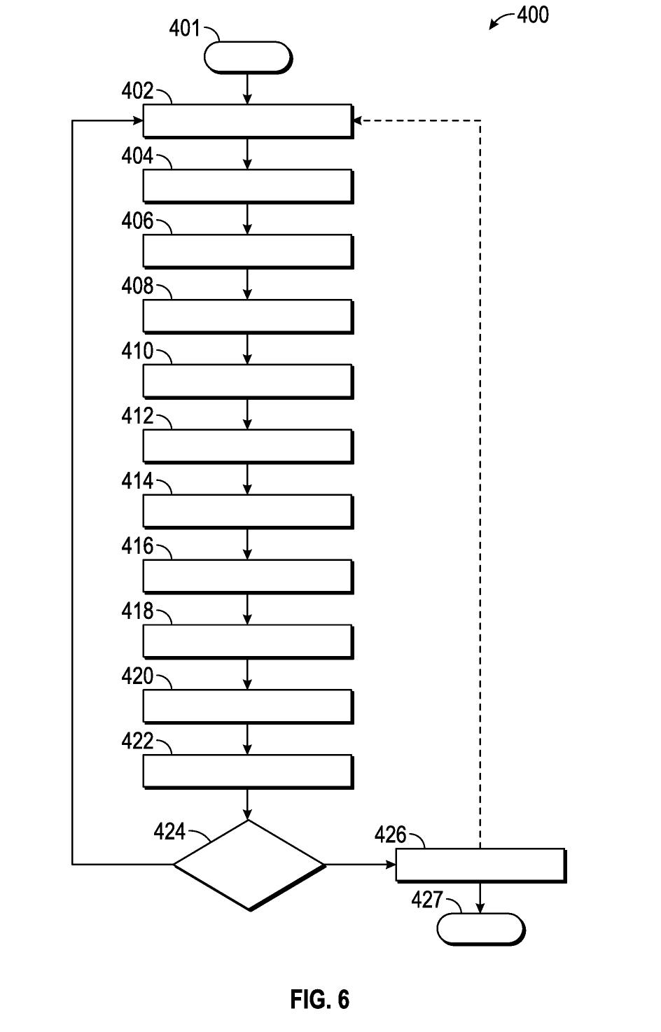

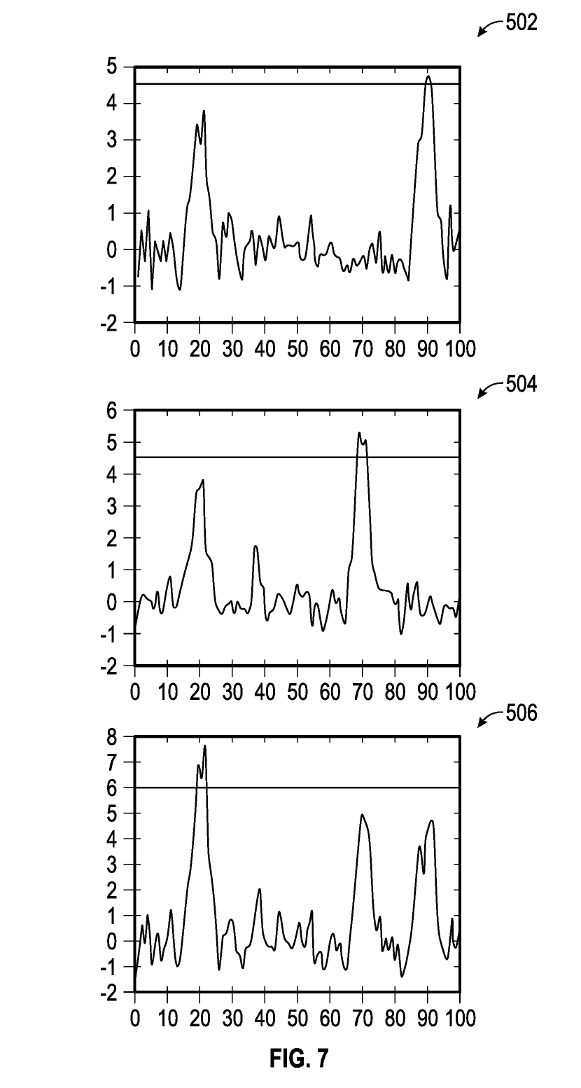

Also in one embodiment, each radar control system 12 generates classifications of the object(s) based on the received radar signals 14 (and/or information related thereto). In addition, in one embodiment, each radar control system 12 broadcasts its classifications to the radar control systems 12 of the other vehicles 10, and also receives similar classifications from the radar control systems 12 of the other vehicles 10. Also in one embodiment, each radar control system 12 then updates its classification based on the various classifications received from the other vehicles 10. In one embodiment, thee functions are performed in accordance with the method 400 described further below in connection with FIGS. 6 and 7.

In FIG. 1, a single object 15 (e.g., a pedestrian) is depicted as being contacted by the radar signals 14 of the radar control systems 12 of each of the nearby vehicles 10 as the object 15 moves within a particular region (or cell) 16. Each vehicle 10 has a different physical position relative to the object 15, so that the radar control system 12 of each vehicle 10 can detect the same object 15 at a different point of view and/or at a different point in time. Also as depicted in FIG. 1, in this example the object 15 is moving with a velocity having a horizontal component 18, a vertical component 20, and a resulting aggregate velocity vector 22. Also as depicted in FIG. 1, the radar signals 14 may be received by the radar control systems 12 of the different vehicles 10 at different respective angles (e.g. angles 24 versus 26 of FIG. 1). In one embodiment, the observation is performed from relatively larger angles (such as those depicted in FIG. 1) to improve performance of the overall system. In one embodiment, the wave forms of the radar signals 14 are orthogonal to one another.

As depicted in FIG. 2, in one embodiment, the radar control systems 12 may provide this functionality while the various vehicles 10 are travelling along the roadway 30 in different lanes (such as the first lane 32, the second lane 34, the third lane 36, and the fourth lane 38) proximate an intersection having a crosswalk 40. As shown in FIG. 2, in this example two pedestrian 15 points are disposed within a common region (or cell) 16 in the crosswalk 40 approximately between the first and second lanes 32, 34. In this example, the two pedestrian 15 points within the common cell 16 refer to a single pedestrian that is detected by the respective radar control systems 12 of two of the vehicle 10 at two distinct locations while moving within the crosswalk 40.

In this example, the pedestrian 15 is located at two distinct locations by a first radar region 50 of a first vehicle 10 (1) travelling in the third lane 36 and a second radar region 52 of a second vehicle 10 (2) travelling in the first lane 32. In the example of FIG. 2, the pedestrian 15 may similarly be detected at various different points by one or more vehicles 10 in various lanes 32, 34, 36, and 38 as the pedestrian 15 walks through the crosswalk 40. In one embodiment, the respective radar control systems 12 of the various vehicles 10 receive the various radar signals 14 from the various radar control systems 12 (from its own vehicle 10 and from other vehicles 10) to classify the pedestrian 15, for example as discussed in greater detail further below in connection with the method 400 of FIGS. 6 and 7. Accordingly, the pedestrian 15 may still be tracked even in cases in which the pedestrian 15 is moving tangentially with respect to the radar system of one particular vehicle (in which case the object may still be tracked using data from radar systems of other nearby vehicles, even if the radar system of the particular vehicle itself cannot detect the tangential movement).

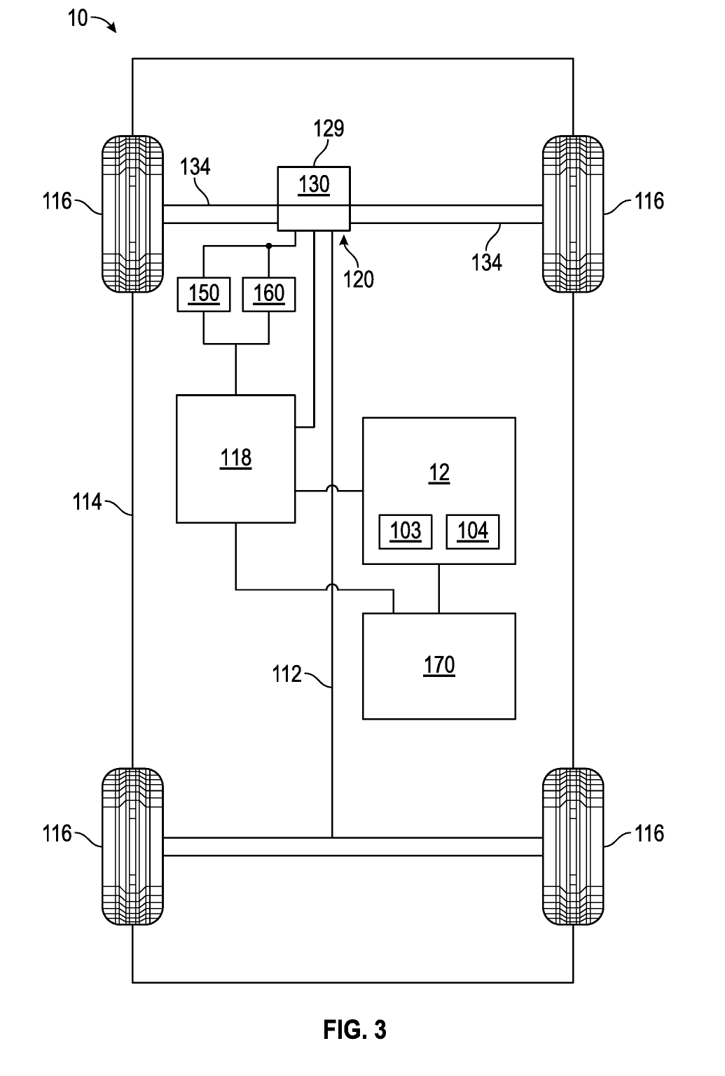

FIG. 3 provides a functional block diagram of an illustrative one of the vehicles 10 of FIGS. 1 and 2, in accordance with an exemplary embodiment. As described in greater detail further below, the vehicle 10 includes the radar control system 12. In the depicted embodiment, the vehicle 10 also includes a chassis 112, a body 114, four wheels 116, an electronic control system 118, a steering system 150, and a braking system 160. The body 114 is arranged on the chassis 112 and substantially encloses the other components of the vehicle 10. The body 114 and the chassis 112 may jointly form a frame. The wheels 116 are each rotationally coupled to the chassis 112 near a respective corner of the body 114.

In the exemplary embodiment illustrated in FIG. 3, the vehicle 10 includes an actuator assembly. The actuator assembly 120 includes at least one propulsion system 129 mounted on the chassis 112 that drives the wheels 116. In the depicted embodiment, the actuator assembly 120 includes an engine 130. In one embodiment, the engine 130 comprises a combustion engine. In other embodiments, the actuator assembly 120 may include one or more other types of engines and/or motors, such as an electric motor/generator, instead of or in addition to the combustion engine.

Still referring to FIG. 3, the engine 130 is coupled to at least some of the wheels 116 through one or more drive shafts 134. In some embodiments, the engine 130 is mechanically coupled to the transmission. In other embodiments, the engine 130 may instead be coupled to a generator used to power an electric motor that is mechanically coupled to the transmission.

The steering system 150 is mounted on the chassis 112, and controls steering of the wheels 116. The steering system 150 includes a steering wheel and a steering column (not depicted). The steering wheel receives inputs from a driver of the vehicle 10. The steering column results in desired steering angles for the wheels 116 via the drive shafts 134 based on the inputs from the driver.

The braking system 160 is mounted on the chassis 112, and provides braking for the vehicle 10. The braking system 160 receives inputs from the driver via a brake pedal (not depicted), and provides appropriate braking via brake units (also not depicted). The driver also provides inputs via an accelerator pedal (not depicted) as to a desired speed or acceleration of the vehicle 10, as well as various other inputs for various vehicle devices and/or systems, such as one or more vehicle radios, other entertainment or infotainment systems, environmental control systems, lightning units, navigation systems, and the like (also not depicted).

Also as depicted in FIG. 3, in certain embodiments the vehicle 10 may also include a telematics system 170. In one such embodiment the telematics system 170 is an onboard device that provides a variety of services through communication with a call center (not depicted) remote from the vehicle 10. In various embodiments the telematics system may include, among other features, various non-depicted features such as an electronic processing device, one or more types of electronic memory, a cellular chipset/component, a wireless modem, a dual mode antenna, and a navigation unit containing a GPS chipset/component. The telematics system 170 may provide various services including: turn-by-turn directions and other navigation-related services provided in conjunction with the GPS chipset/component, airbag deployment notification and other emergency or roadside assistance-related services provided in connection with various sensors and/or sensor interface modules located throughout the vehicle, and/or infotainment-related services where music, internet web pages, movies, television programs, videogames, and/or other content.

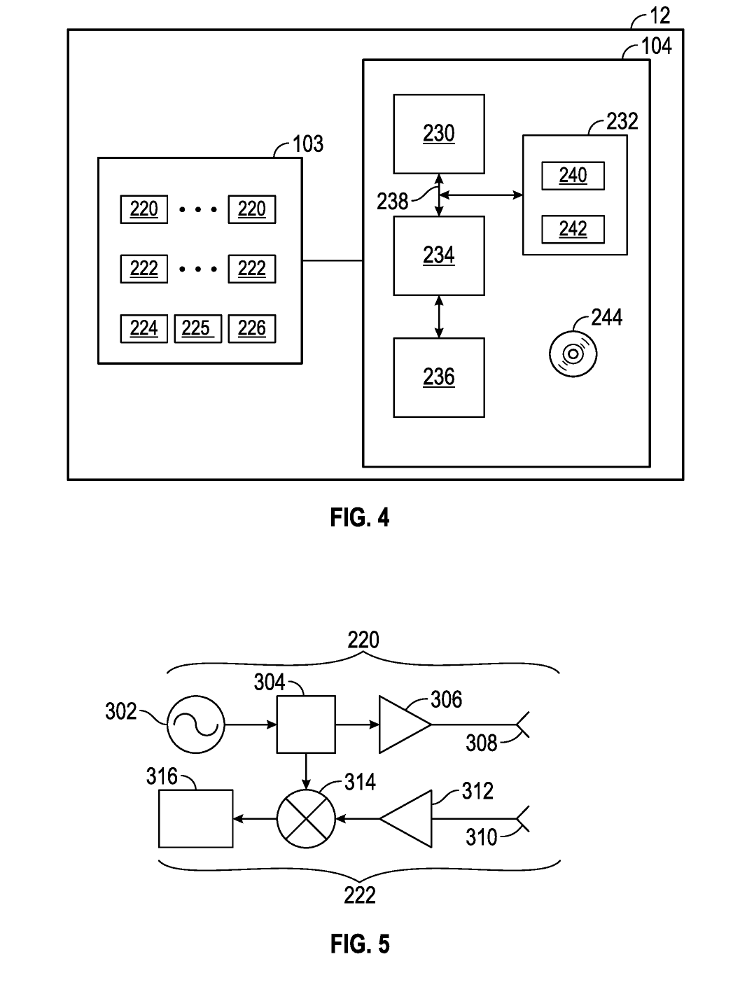

The radar control system 12 is mounted on the chassis 112. As mentioned above, the radar control system 12 provides for classification of objects on or around the roadway in which the vehicle 10 is travelling, using radar signals and classifications from its own system as well as the radar control systems of other vehicles. In one example, the radar control system 12, provides these functions in accordance with the method 400 described further below in connection with FIG. 6. As depicted in FIG. 3, the radar control system 12 includes a radar system 103 and a controller 104 (described further below in connection with FIGS. 4 and 5).

While the radar control system 12, the radar system 103, and the controller 104 are depicted as being part of the same system, it will be appreciated that in certain embodiments these features may comprise two or more systems. In addition, in various embodiments the radar control system 12 may comprise all or part of, and/or may be coupled to, various other vehicle devices and systems, such as, among others, the actuator assembly 120, and/or the electronic control system 118.

With reference to FIG. 4, a functional block diagram is provided for the radar control system 12 of FIG. 3, in accordance with an exemplary embodiment. As noted above, the radar control system 12 includes the radar system 103 and the controller 104 of FIG. 1.

In the depicted embodiment, the radar system 103 comprises a multiple input, multiple output (MIMO) radar system with multiple transmitters (also referred to herein as transmission channels) 220 and multiple receivers (also referred to herein as receiving channels) 222. The transmitters 220 transmit radar signals for the radar system 103. After the transmitted radar signals contact one or more objects on or near a road on which the vehicle 10 is travelling and is reflected/ redirected toward the radar system 103, the redirected radar signals are received by the receivers 222 of the radar system 103 for processing. In addition, the receivers 222 also receive similar redirected radar signals that originated from respective radar systems of other nearby vehicles, after being similarly redirected after contacting the one or more objects. In one embodiment, certain of the receivers 222 receive the return radar signals stemming from radar signals that were originated from the radar system 103 of the host vehicle (i.e., the vehicle on which the receiver 222 resides), while certain other receivers 222 receive return radar signals stemming from the radar signals that were originated from the radar 103 of other nearby vehicles. In one embodiment, radar system 103 of a particular vehicle receives signals from all vehicles surrounding it. Also in one embodiment, all vehicles obtain different information on the target due to their different spatial location. Accordingly, in one embodiment, every nearby vehicle obtains some information on the target and broadcasts the information, and the vehicle that is interested in that information to classify the target creates MIMO radar-based information on the target by gathering these multiple signals.

With reference to FIG. 5, a representative one of the transmission channels 220 is depicted along with a respective one of the receiving channels 222 of the radar system of FIG. 4, in accordance with an exemplary embodiment. As depicted in FIG. 4, each transmitting channel 220 includes a signal generator 302, a filter 304, an amplifier 306, and an antenna 308. Also as depicted in FIG. 4, each receiving channel 222 includes an antenna 310, an amplifier 312, a mixer 314, and a sampler/digitizer 316. In certain embodiments the antennas 308, 310 may comprise as single antenna, while in other embodiments the antennas 308, 310 may comprise separate antennas. Similarly, in certain embodiments the amplifiers 306, 312 may comprise a single amplifier, while in other embodiments the amplifiers 306, 312 may comprise separate amplifiers. In addition, in certain embodiments multiple transmitting channels 220 may share one or more of the signal generators 302, filters 304, amplifiers 306, and/or antennae 308. Likewise, in certain embodiments, multiple receiving channels 222 may share one or more of the antennae 310, amplifiers 312, mixers 314, and/or samplers/digitizers 316.

The radar system 103 generates the transmittal radar signals via the signal generator(s) 302. The transmittal radar signals are filtered via the filter(s) 304, amplified via the amplifier(s) 306, and transmitted from the radar system 103 (and from the vehicle 10 to which the radar system 103 belongs, also referred to herein as the “host vehicle”) via the antenna(e) 308. The transmitting radar signals subsequently contact other vehicles and/or other objects on or alongside the road on which the host vehicle is travelling. After contacting the other vehicles and/or other objects, the radar signals are reflected, and travel from the other vehicles and/or other objects in various directions, including some signals returning toward the host vehicle. The radar signals returning to the host vehicle (also referred to herein as received radar signals) are received by the antenna(e) 310, amplified by the amplifier(s) 312, mixed by the mixer(s) 314, and digitized by the sampler(s)/digitizer(s) 316.

Returning to FIG. 4, in certain embodiments the radar system 103 also includes, among other possible features, a memory 224, an interface 225, and a processing unit 226. The received radar signals from the receiving channels 222 are provided to the processing unit 226 of the radar system 103 (and/or the processor 230 of the controller 104, discussed further below) for classification of the objects, and results pertaining thereto are stored in the memory 224 of the radar system 103 (and/or the memory 232 of the controller 104, discussed further below). The processing unit 226 of the illustrated embodiment is capable of executing one or more programs (i.e., running software) to perform various tasks instructions encoded in the program(s). The interface 225 (e.g., a transceiver) (and/or the interface 234 of the controller 104, discussed further below) is used to transmit or broadcast the classifications to other vehicles, and to receive similar classifications from the other vehicles, which are also stored in the memory 224 of the radar system 103 (and/or the memory 232 of the controller 104, discussed further below). The processing unit 226 (and/or the processor 230 of the controller 104, discussed further below) then updates its initial classification based on the classifications received from the other vehicles.

The processing unit 226 may be a microprocessor, microcontroller, application specific integrated circuit (ASIC) or other suitable device as realized by those skilled in the art. Of course, the radar system 103 may include multiple memories 224, interfaces 225, and/or processing units 226, working together or separately, as is also realized by those skilled in the art. In addition, it is noted that in certain embodiments, the functions of the memory 224, the interface 225, and/or the processing unit 226 may be performed in whole or in part by one or more other memories, interfaces, and/or processors disposed outside the radar system 103, such as the memory 232, the interface 234, and the processor 230 of the controller 104 described further below.

As depicted in FIG. 4, the controller 104 is coupled to the radar system 103. Similar to the discussion above, in certain embodiments the controller 104 may be disposed in whole or in part within or as part of the radar system 103. In addition, in certain embodiments, the controller 104 is also coupled to one or more other vehicle systems (such as the electronic control system 118 of FIG. 3). The controller 104 receives and processes the information sensed or determined from the radar system 103, provides detection, classification, and tracking of objects, and implements appropriate vehicle actions based on this information. The controller 104 generally performs these functions in accordance with the method 400 discussed further below in connection with FIGS. 6 and 7.

As depicted in FIG. 4, the controller 104 comprises a computer system. In certain embodiments, the controller 104 may also include one or more of the radar system 103, additional sensor(s) 104, and/or one or more other systems. In addition, it will be appreciated that the controller 104 may otherwise differ from the embodiment depicted in FIG. 4. For example, the controller 104 may be coupled to or may otherwise utilize one or more remote computer systems and/or other control systems, such as the electronic control system 118 of FIG. 3.

In the depicted embodiment, the computer system of the controller 104 includes a processor 230, a memory 232, an interface 234, a storage device 236, and a bus 238. The processor 230 performs the computation and control functions of the controller 104, and may comprise any type of processor or multiple processors, single integrated circuits such as a microprocessor, or any suitable number of integrated circuit devices and/or circuit boards working in cooperation to accomplish the functions of a processing unit. During operation, the processor 230 executes one or more programs 240 contained within the memory 232 and, as such, controls the general operation of the controller 104 and the computer system of the controller 104, generally in executing the steps of the processes described herein, such as those of the method 400 described further below in connection with FIGS. 6 and 7.

The memory 232 can be any type of suitable memory. This would include the various types of dynamic random access memory (DRAM) such as SDRAM, the various types of static RAM (SRAM), and the various types of non-volatile memory (PROM, EPROM, and flash). In certain examples, the memory 232 is located on and/or co-located on the same computer chip as the processor 230. In the depicted embodiment, the memory 232 stores the above-referenced program 240 along with one or more stored values 242 for use in making the determinations.

The bus 238 serves to transmit programs, data, status and other information or signals between the various components of the computer system of the controller 104. The interface 234 allows communication to the computer system of the controller 104, for example from a system driver and/or another computer system, and can be implemented using any suitable method and apparatus. In one embodiment, the interface 234 transmits (or broadcasts) classifications of the object to other vehicles, and also receives similar classifications that are transmitted (or broadcast) from other vehicles. The interface 234 can include one or more network interfaces to communicate with other systems or components. In one embodiment, the interface 234 includes a transceiver. The interface 234 may also include one or more network interfaces to communicate with technicians, and/or one or more storage interfaces to connect to storage apparatuses, such as the storage device 236.

The storage device 236 can be any suitable type of storage apparatus, including direct access storage devices such as hard disk drives, flash systems, floppy disk drives and optical disk drives. In one exemplary embodiment, the storage device 236 comprises a program product from which memory 232 can receive a program 240 that executes one or more embodiments of one or more processes of the present disclosure, such as the method 400 (and any sub-processes thereof) described further below in connection with FIGS. 6 and 7. In another exemplary embodiment, the program product may be directly stored in and/or otherwise accessed by the memory 232 and/or a disk (e.g., disk 244), such as that referenced below.

The bus 238 can be any suitable physical or logical means of connecting computer systems and components. This includes, but is not limited to, direct hard-wired connections, fiber optics, infrared and wireless bus technologies. During operation, the program 240 is stored in the memory 232 and executed by the processor 230.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 230) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will similarly be appreciated that the computer system of the controller 104 may also otherwise differ from the embodiment depicted in FIG. 4, for example in that the computer system of the controller 104 may be coupled to or may otherwise utilize one or more remote computer systems and/or other control systems.

FIG. 6 is a flowchart of a method 400 for implementing a radar system of a vehicle, in accordance with an exemplary embodiment. The method 400 can be implemented in connection with the vehicles 10 of FIGS. 1-3 and the radar control system 12 of FIGS. 3-5, in accordance with an exemplary embodiment. The method 400 is also discussed below in connection with FIG. 7, which provides a set of graphical illustrations pertaining to the classification of an object in accordance with the method 400, in accordance with an exemplary embodiment.

As depicted in FIG. 6, once the method 400 begins at 401, the method 400 includes transmitting radar signals at 402. The radar signals are, in one example, transmitted via the various transmitting channels 220 of the radar system 103 of the host vehicle 10 (as referenced in FIGS. 3-5). The transmitted radar signals are transmitted from the vehicle 10 as the vehicle 10 is travelling along a road, and reflected from objects on or around the road. As mentioned above, in various embodiments the term “object” may refer to any moving or non-moving matter on or along the roadway, including, but not limited to, a pedestrian, a bicyclist, an animal, a motorcycle, another automobile, another type of vehicle, a boulder, a tree, a power line, roadway debris, and/or one or more various other types of objects.

After the radar signals are reflected from objects on or around the road, return radar signals from the radar system 103 of the host vehicle 10 are received by the radar system 103 at 404 of FIG. 6, to generate radar data. In one example, the received radar signals are received via the various receiving channels 222 of the radar system 103 of the host vehicle 10 (as referenced in FIGS. 3-5). In one embodiment, the return radar signals of 404 represent different angles with respect to the object and/or different locations of the object, for example because the return radar signals have been transmitted by various different transmitting channels 220 and received via various different receiving channels 222 of the radar system 103 of the vehicle 10. The information obtained at 404 is also referred to herein as “first information”. In one embodiment, the first information comprises the radar signals themselves from the host vehicle at 404. In another embodiment, the first information comprises summary information (e.g. coordinates and/or angles pertaining to the objects and/or path of travel of the radar signals) from the radar signals of the host vehicle.

In addition, return radar signals are received from other vehicles at 406 of FIG. 6. In one example, during 406 the various receiving channels 222 of the radar system 103 of the host vehicle 10 receive return radar signals that originally emanated from the radar systems 103 of other nearby vehicles that are in the proximity of the host vehicle 10 and that are redirected after contacting the objects on or near the roadway. The return radar signals of 406 from the other vehicles provide additional different angles with respect to the object and/or different locations of the object, for example due to the different positioning of the other vehicles with respect to the object. The information obtained at 406 is also referred to herein as “second information”. In one embodiment, the first information comprises the radar signals themselves from the other vehicles at 406. In another embodiment, the second information comprises summary information (e.g. coordinates and/or angles pertaining to the objects and/or path of travel of the radar signals) from the radar signals of the other vehicles. The waveforms of the various radar signals of 404 and 406 are generally orthogonal to one another.

Processing is performed for the radar data at 408-412. As part of the processing, the objects are initially identified at 408 using the radar data (i.e. first information and second information) of 404 and 406. The objects are classified at 410 with determinations pertaining to the types, sizes, shapes, dimensions, placement, positions, and/or movement of the objects, also using the radar data (i.e. first information and second information) of 404 and 406. In one embodiment, geographic coordinates and physical measurements (e.g., length, width, height) of the objects are determined, along with the objects' proximity to and/or movement with respect to the vehicle 10, using the radar data (i.e. first information and second information) of 404 and 406. In one such embodiment, the classifications are made utilizing a range and an azimuth value using the radar data of 404 and the radar data of 406 as well as utilizing Doppler information using radar data of 404 and the radar data of 406 with respect to each potential object detected by a radar system of one of the vehicles within a common range or cell (e.g. the cell 16 depicted in FIGS. 1 and 3). As a result, a classification output is generated at 412. In one embodiment, the classification comprises a probability mapping as to possible characteristics (e.g., type, size, dimensions, location, and/or movement) of the object. In one embodiment, the probability mapping of 412 is generated by first denoting the object existence (or characteristic) likelihood in spatial cell x for radar sensor “i” in accordance with the following equation:

P(xᵢ|l, o=0,1) (Equation 1).

As used herein, the classification of 412 may be referred to as a first classification, a first signature, and/or a first probability, pertaining to the object as generated by the host vehicle. The determinations, processing, and classifications of 408-12 are performed by a processor, such as the processing unit 226 and/or the processor 230 of FIG. 4.

The classification of 412 is broadcast by the vehicle at 414. In one embodiment, the classification is broadcast by the interface 225 of the radar system 103 of FIG. 4 at 414. In another embodiment, the classification is broadcast by the interface 234 of the controller 104 of FIG. 4 at 414. In one embodiment, the classification is broadcast by the host vehicle 10 for use by other nearby vehicles, which also similarly broadcast their own respective classifications for use by the other vehicles and the host vehicle 10. In one embodiment, the entire classification is broadcast at 414. In another embodiment, only the feature vector of the object is broadcast at 414 to reduce communication overhead.

Classifications from other vehicles are received at 416. In one embodiment, the target vehicle 10 receives the respective classifications from the other nearby vehicles pertaining to the same object(s) to which the classification of the host vehicle 10 of 414 pertained. In one embodiment, the classifications from the other vehicles are received by the interface 225 of the radar system 103 of FIG. 4 of the host vehicle 10 at 416. In another embodiment, the classifications from the other vehicles are received by the interface 234 of the controller 104 of FIG. 4 at 416. As used herein, the classifications of 416 may be referred to as second classifications, second signatures, and/or second probabilities, pertaining to the object as generated by the other vehicles.

The classifications from the other vehicles of 416 are provided to a processor for processing at 418, such as the processing unit 226 and/or the processor 230 of FIG. 4. The processor generates an updated classification at 420 based on the processing. Specifically, during 420, the processor updates the classification of 412 using the classifications from the other vehicles of 416. As used herein, the updated classifications of 426 may be referred to as a third classification, a third signature, and/or a third probability, pertaining to the object. In one embodiment, the updated classification is generated at 420 by aggregating data and evidence from each of the classifications in time T on the detected in cell x using the following equation:

log P(x₁^{T}, . . . , xₙ^{T}|l, o=0,1)=Σ₍ₗ₌₁₎ⁿ log P(xᵢ^{T}|l, o=0,1) (Equation 2)

An illustrative example of such an updated classification is provided in FIG. 7, in accordance with an exemplary embodiment. Specifically, FIG. 7 depicts an exemplary first probability mapping 502 for the object corresponding to the first classification from the host vehicle of 412. FIG. 7 also depicts a second probability mapping 504 for the object corresponding to one or more of the second classifications from the other vehicles of 416. In addition, FIG. 7 depicts a third probability mapping 506 corresponding to the updated classification of 420. As shown in FIG. 7, in one embodiment, the third probability mapping 506 is generated by combining the first and second mappings 502, 504 together, for example using mathematical regression techniques. In one embodiment, an illustrative example may include a host vehicle that detects a target and is interested in classifying the target. Also in one embodiment, the host vehicle checks whether adjacent vehicles transmitted to him the information about this target of interest, for example a pedestrian. If the answer is “yes’< then the host vehicle uses the information about the adjacent vehicles locations and combines their measurements to create a distributed MIMO signal about the target of interest. By using information the host vehicle can classify the target with high fidelity and also to estimate its direction of motion.

Returning to FIG. 6, the object is further tracked at 422. In one embodiment, the object is tracked over time using updated radar data in new iterations of 404 and 406, along with updated classifications in new iterations of 412, 416, and 420. For example, in one embodiment, the position and movement of an object 15 (FIG. 2) with respect to the host vehicle 10 is tracked over time using is data and these classifications. The tracking is performed by a processor, such as the processing unit 226 and/or the processor 230 of FIG. 4.

At 424, a determination is made as to whether a vehicle action is required. In one embodiment, the determination pertains to whether a vehicle action is required for avoidance of the object tracked at 422 (e.g., another vehicle, a pedestrian, and/or another object). In one embodiment, the determination of 424 is made using the classifications of 412, 416, and 420 and the tracking of 422. In one embodiment, a vehicle action may be required if a distance between the vehicle 10 and the object 15 is less than a predetermined threshold or an estimated time of contact between the vehicle 10 and the object is less than a predetermined threshold. The determination of 424 is performed by a processor, such as the processing unit 226 and/or the processor 230 of FIG. 4.

If a determination is made in 424 that an action is not necessary, then no action is taken. Instead, the process returns to 402, as new radar data is generated in a new iteration.

Conversely, if a determination is made in 424 that an action is necessary, then the action is taken at 426. In certain embodiments, the action comprises an alert, such as a visual or audio alert to the driver. In addition, in certain embodiments, the action comprises an automatic vehicle control action, such as initiation of automatic braking by the braking system 160 and/or automatic steering by the steering system 150. Also in one embodiment, the action is initiated by a processor (such as the processing unit 226 and/or the processor 230 of FIG. 4) outputting one or more control signals to an appropriate vehicle system, such as the steering system 150 and/or the braking system 160 of FIG. 1 and/or an alert unit (not depicted) of the vehicle 10 of FIG. 1.

In one example, if a distance between the host vehicle 10 and the object 15 is less than a predetermined threshold (or an estimated time of contact between the host vehicle 10 and the object 15 under their current respective trajectories is less than a predetermined threshold), then an alert (e.g., a visual or audio alert to the driver) may be provided and/or an automatic vehicle control action (e.g., automatic braking and/or automatic steering) may be initiated, for example by the processor outputting one or more control signals for the steering system 150 and/or the braking system 160 of FIG. 3.

While the action is not depicted in FIG. 6 until 426, it will be appreciated that in certain situations actions may be taken earlier in the method 400, for example if any of the classifications of 412, 416, and 420 and/or the tracking of 422 provide an earlier indication that a vehicle action is appropriate. In certain embodiments, the method 400 ends at 427 once the action is performed. In certain other embodiments, the method 400 returns to 402 while the vehicle action is taking place, or subsequent to the vehicle action (as depicted in phantom in FIG. 6).

Accordingly, the method 400 provides for detection, classification, and tracking of objects proximate a roadway on which a host vehicle is travelling. The method 400 uses radar signals and classifications from the host vehicle's radar control system as well as those of other nearby vehicles for classification of the objects. The method 400 thus takes advantage of the diversity of information available from the different aspect ratios provided the different vehicles at different locations and at different points in time, which, when aggregated, provide for potentially more comprehensive classification and tracking of the objects. The method 400 also allows for tracking of the objects in this manner even in cases in which the object (e.g., a pedestrian) is moving tangentially with respect to the radar system of one particular vehicle (in which case the object may still be tracked using data from radar systems of other nearby vehicles, even if the radar system of the particular vehicle itself cannot detect the tangential movement). In addition, in one embodiment, each of the vehicles generates its own classification of the object, which can then be used by other nearby vehicles to update their own respective classifications of the object.

It will be appreciated that the disclosed methods, systems, and vehicles may vary from those depicted in the Figures and described herein. For example, the vehicles 10, the radar control system 12, the radar system 103, the controller 104, and/or various components thereof may vary from that depicted in FIGS. 1-5 and described in connection therewith. In addition, it will be appreciated that certain steps of the method 400 may vary from those depicted in FIGS. 6 and 7 and/or described above in connection therewith. It will similarly be appreciated that certain steps of the method described above may occur simultaneously or in a different order than that depicted in FIG. 6 and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

What is claimed is:

1. A method for classifying an object proximate a first vehicle having a first radar system, the method comprising the steps of:
receiving first information from a first radar signal of the first radar system pertaining to the object;
receiving second information from a second radar signal of a second vehicle pertaining to the object; and
classifying the object using the first information and the second information.

2. The method of claim 1, wherein:
the receiving the first information comprises receiving the first information from the first radar signal of the first radar system pertaining to the object, the first radar system comprising a multiple input, multiple output (MIMO) radar system.

3. The method of claim 1, wherein the first radar signal and the second radar signal have respective waveforms that are orthogonal to one another.

4. The method of claim 1, wherein the classifying the object comprises classifying the object using a range and an azimuth value using the first information and the second information.

5. The method of claim 1, wherein the classifying the object comprises classifying the object using Doppler information using the first information and the second information.

6. The method of claim 1, wherein the classifying the object comprises:
determining a first probability for the object based on the first information;
determining a second probability for the object based on the second information; and
determining a third probability for the object based on the first probability and the second probability.

7. The method of claim 1, wherein the classifying the object comprises generating a classification based on the first information and the second information, and the method further comprises:
broadcasting the classification for use by other vehicles.

8. The method of claim 1, wherein the classifying the object comprises generating a first classification based on the first information and the second classification, and the method further comprises:
receiving a second classification broadcast by a separate vehicle other than the first vehicle; and
updating the first classification based on the second classification.

9. A radar control system comprising:
a first receiver configured to receive first information from a first radar system of a first vehicle pertaining to an object proximate the first vehicle;
a second receiver configured to receive second information from a second radar system of a second vehicle pertaining to the object; and
a processor coupled to the first receiver and the second receiver and configured to classify the object using the first information and the second information.

10. The radar control system of claim 9, wherein the first radar system comprises a multiple input, multiple output (MIMO) radar system.

11. The radar control system of claim 9, wherein the first information pertains to a first radar signal of the first radar system, the second information pertains to a second radar signal of the second radar system, and the first radar signal and the second radar signal have respective waveforms that are orthogonal to one another.

12. The radar control system of claim 9, wherein the processor is further configured to classify the object using a range and an azimuth value using the first information and the second information.

13. The radar control system of claim 9, wherein the processor is further configured to classify the object using Doppler information using the first information and the second information.

14. The radar control system of claim 9, wherein the processor is further configured to:
determine a first probability for the object based on the first information;
determine a second probability for the object based on the second information; and
determine a third probability for the object based on the first probability and the second probability.

15. The radar control system of claim 9, wherein:
the processor is further configured to generate a classification based on the first information and the second information; and
the radar control system further comprises a transmitter configured to broadcast the classification for use by other vehicles.

16. The radar control system of claim 9, wherein:
the processor is configured to generate a first classification based on the first information and the second classification;
the radar control system further comprises an interface configured to receive a second classification broadcast by a separate vehicle other than the first vehicle; and
the processor is further configured to generate a third classification based on the first classification and the second classification.

17. A radar control system comprising:
a receiver configured to receive a radar signal of a radar system of a first vehicle pertaining to an object proximate the first vehicle;
an interface configured to configured to receive a second classification broadcast by a separate vehicle other than the first vehicle; and
a processor configured to:
generate a first classification based on the radar signal; and
update the first classification based on the second classification.

18. The radar control system of claim 17, wherein the radar system comprises a multiple input, multiple output (MIMO) radar system.

19. The radar control system of claim 17, further comprising:
a second receiver configured to receive a second radar signal of a second radar system of an additional vehicle pertaining to the object;
wherein the processor is configured to generate the first classification based on the radar signal and the second radar signal.

20. The radar control system of claim 17, further comprising:
a transmitter configured to transmit the first classification to other vehicles.
